(19) United States
(12) Patent Application Publication
(10) Pub. No.: US 2009/0108636 A1
(43) Pub. Date: Apr. 30, 2009

(54) Utility Vehicle Canopy

(75) Inventors: Bradley J. Hanson, North Augusta, SC (US); Donald S. Hanson, JR., Evans, GA (US); Anthony R. Rossello, Eagle Mountain, UT (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/928,249

(22) Filed: Oct. 30, 2007

(51) Int. Cl. B60R 27/00

(52) U.S. Cl. 296/213

(57) ABSTRACT

A utility vehicle canopy including a pair of lateral rain channels formed along a forward portion and an aft portion of a top side of the canopy. The canopy additionally includes a pair of longitudinal rain channels formed along a driver side portion and a passenger side portion of the canopy. The longitudinal rain channels interconnected with the lateral rain channels. The vehicle canopy further includes at least one outlet rain channel formed in the top side of the canopy. The outlet rain channel extends between an outer edge of the canopy and one of the lateral rain channels and/or one of the longitudinal rain channels.

### FIELD

The present teachings relate generally to canopies for light-weight utility vehicles.

### BACKGROUND

The statements in this section merely provide background information related to the present disclosure and may not constitute prior art.

Known light-weight utility vehicles, such as small cargo/maintenance vehicles, shuttle vehicles or golf cars, often include a canopy that covers or overhangs a passenger seating portion of the vehicle. Such canopies generally provide protection to the vehicle passengers, i.e., driver and rider(s), from adverse weather, e.g., rain, hail, or snow. Typically, utility vehicle canopies have a generally flat top surface that do not direct or control the shedding liquids, such as rain water and/or water used to wash the vehicle, shedding from the top surface of the canopies. Therefore, when such liquids shed from the canopy top surface in such an uncontrolled, undirected fashion, the liquids can pour onto occupants of the vehicle, i.e., the driver and/or rider(s).

Additionally, such known vehicle canopies are typically somewhat flexible and can easily sag over time due to exposure to environmental elements. Accordingly, such vehicle canopies often collect liquids such as rain water and/or water used to wash the vehicle. The collected water can then pour, or dump, off the top surface of the canopies in a random, undirected, uncontrolled manner when the vehicle turns or traverses sloped terrain. Such random, undirected, uncontrolled dumping of the collected water can have a tendency to pour onto occupants of the vehicle, i.e., a driver and/or rider(s).

### SUMMARY

A utility vehicle canopy is provided. In accordance with various embodiments, the vehicle canopy includes a pair of lateral rain channels formed along a forward portion and an aft portion of a top side of the canopy. The canopy additionally includes a pair of longitudinal rain channels formed along a driver side portion and a passenger side portion of the canopy. The longitudinal rain channels are interconnected with the lateral rain channels. The vehicle canopy further includes at least one outlet rain channel formed in the top side of the canopy. The outlet rain channel extends between an outer edge of the canopy and one of the lateral rain channels and/or one of the longitudinal rain channels.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is side view of a golf car including a canopy, in accordance with various embodiments of the present disclosure.

FIG. 2 is an isometric top view of the canopy shown in FIG. 1, including a plurality of rain channels, in accordance with various embodiments.

FIG. 3 is a bottom view of the canopy shown in FIG. 1, illustrating various features of the bottom side of the canopy, in accordance with various embodiments.

FIG. 4 is a cross-sectional view of the canopy shown in FIG. 1 along line A-A of FIG. 3, illustrating reinforcing ribs of the canopy, in accordance with various embodiments.

FIG. 5 is side view of the canopy shown in FIG. 1, illustrating a crowned top surface of the canopy, in accordance with various embodiments.

FIG. 6 is a bottom view of the canopy shown in FIG. 1, illustrating one or more drip edges along various portion of the bottom side of the canopy, in accordance with various embodiments.

FIG. 7A illustrates a portion of a cross-sectional view along line B-B of the canopy shown in FIG. 6, in accordance with various embodiments.

FIG. 7B illustrates a portion of a cross-sectional view along line B-B of the canopy shown in FIG. 6, in accordance with various other embodiments.

FIG. 8A is cross-sectional view along line B-B of the canopy shown in FIG. 6, in accordance with various embodiments.

FIG. 8B is cross-sectional view along line C-C of the canopy shown in FIG. 6, in accordance with various other embodiments.

### DETAILED DESCRIPTION

The following description is merely exemplary in nature and is in no way intended to limit the present teachings, application, or uses. Throughout this specification, like reference numerals will be used to refer to like elements.

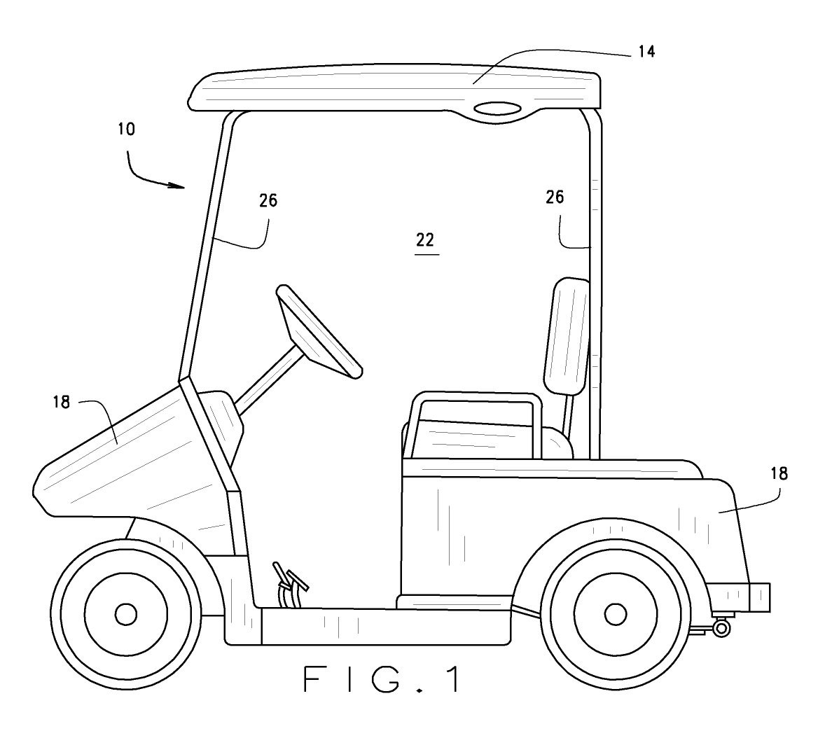

Referring to FIG. 1, a light-weight utility vehicle 10 includes a canopy 14, in accordance with various embodiments of the present disclosure. The canopy 14 is connected to a vehicle body 18, and supported above a passenger seating area or compartment 22, by a plurality of canopy support struts 26. The canopy 14 covers or overhangs the passenger compartment 22 to generally provide protection to the vehicle passenger(s), i.e., driver and/or rider(s), from adverse or harsh weather such as rain, sleet, hail, snow and sun.

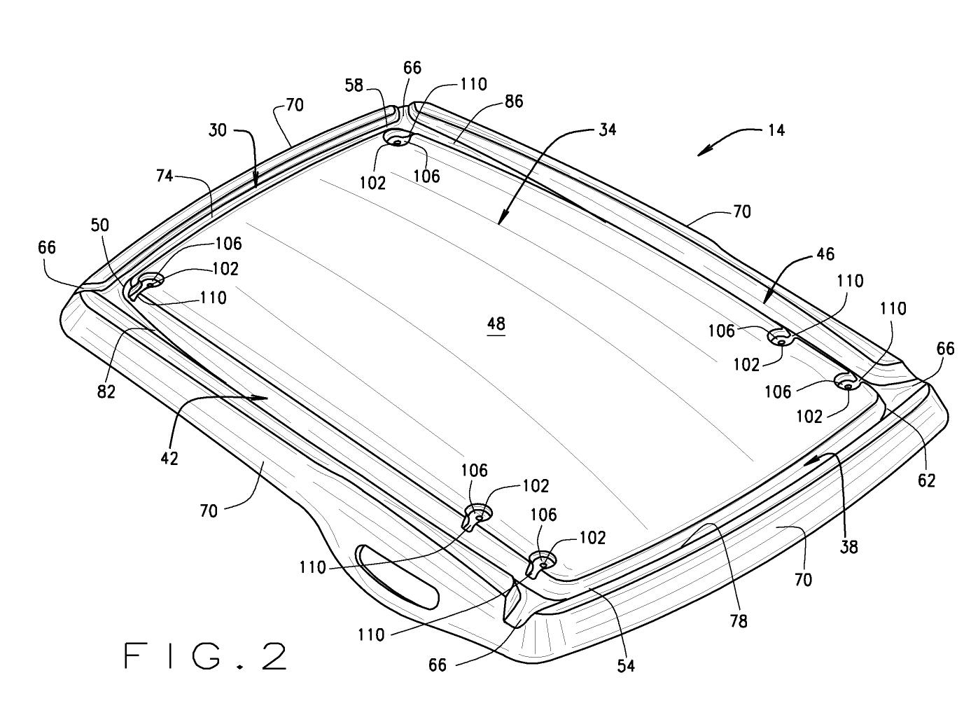

Referring to FIG. 2, in accordance with various embodiments, the canopy 14 includes a forward lateral rain channel 30 formed along a forward portion of a top side 34 of the canopy 14. The canopy 14 additionally includes an aft lateral rain channel 38 formed along an aft portion of the top side 34, a driver side longitudinal rain channel 42 formed along a driver side portion of the top side 34 and a passenger side longitudinal rain channel 46 formed along a passenger side portion of the top side 34. The forward and aft lateral rain channels 30 and 38, and the driver and passenger side longitudinal rain channels 42 and 46 are formed in the canopy 14 such that any liquids, for example, rain water or water used to clean the vehicle 10, that fall onto the top side 34 will shed from a domed center panel 48 of the canopy 14 into the rain channels 30, 38, 42 and 46. As described further below, the domed center panel 48 is domed such that the domed center panel 48 has a crowned lateral profile and crowned longitudinal profile.

The driver side longitudinal rain channel 42 is interconnected between a driver side end 50 of the forward lateral rain channel 30 and a driver side end 54 of the aft lateral rain channel 38. Therefore, liquid flowing into the forward and aft lateral rain channels 30 and 38 can flow into the driver side longitudinal rain channel 42. The passenger side longitudinal rain channel 46 is interconnected between a passenger side end 58 of the forward lateral rain channel 30 and a passenger side end 62 of the aft lateral rain channel 38. Therefore, liquid flowing into the forward and aft lateral rain channels 30 and 38 can also flow into the passenger side longitudinal rain channel 46. Furthermore, the lateral rain channels 30 and 38, and the longitudinal rain channels 42 and 46 are each formed within the canopy 14 to have depth sufficiently deep so that under most all conditions, the rain channels 30, 38, 42 and 46 will channel and direct the fluid off if the canopy 14, as described herein, without the rain channels 30, 38, 42 and 46 overflowing. For example, in various embodiments, the rain channels 30, 38, 42 and 46 can each have a depth between approximately 1 inch and 3 inches, e.g., 2 inches.

In various embodiments, the canopy 14 further includes at least one outlet rain channel 66 formed in the top side 34. The outlet rain channel(s) 66 extend between an outer edge 70 of the canopy 14 and at least one of the forward and aft lateral rain channels 30 and 38 and/or at least one of the driver and passenger side longitudinal rain channels 42 and 46. For example, the canopy 14 can include an outlet rain channel 66 extending between the canopy outer edge 70 and one or more of the rain channels 30, 38, 42 and 46. Or, as exemplarily illustrated in FIG. 2, the canopy 14 can include an outlet rain channel 66 extending between one or more junctions or corners, where the forward and aft lateral rain channels 30 and 38 interconnect with the driver and passenger side rain channels 42 and 46, and the canopy outer edge 70. Accordingly, liquid flowing through the lateral and longitudinal rain channels 30, 38, 42 and 46 will flow through the one or more outlet rain channels 66 and off of the canopy 14.

The forward rain channel 30 is formed in the top side 34 to include a bottom surface 74 and the aft rain channel 38 is formed in the top side 34 to include a bottom surface 78. In various embodiments, one or both of the forward and aft lateral rain channel bottom surfaces 74 and 78 are crowned. More particularly, a center section of one or both forward and aft lateral rain channel bottom surfaces 74 and 78 is higher than opposing end sections of the respective forward and aft lateral rain channel bottom surfaces 74 and 78. Therefore, liquid flowing within the forward and/or aft lateral rain channels 30 and/or 38 will flow from the center sections toward the opposing end sections of the respective forward and aft lateral rain channels 30 and 38. For example, the center section of one or both forward and aft lateral rain channel bottom surfaces 74 and 78 can be between approximately ½ inch and 1½ inches higher than the opposing end sections of the respective forward and aft lateral rain channel bottom surfaces 74 and 78.

Similarly, the driver side and passenger side longitudinal rain channels 42 and 46 are formed within the top side 34 of the canopy 14 to include bottom surfaces 82 and 86, respectively. In various embodiments, one or both of the driver and passenger longitudinal rain channel bottom surfaces 82 and 86 is sloped. That is, one end of the driver side and/or passenger side longitudinal rain channel bottom surfaces 82 and/or 86 is higher than an opposing end of the respective driver side and/or passenger side longitudinal rain channel bottom surface 82 and/or 86. Therefore, liquid flowing within the driver side and/or passenger side longitudinal rain channels 42 and/or 46 will flow from the high ends to the low ends. For example, one end of the driver side and/or passenger side longitudinal rain channel bottom surfaces 82 and/or 86 can be between approximately ½ inch and 1½ inches higher than the opposing end of the respective driver side and/or passenger side longitudinal rain channel bottom surface 82 and/or 86.

In various embodiments, the forward end of the driver side and/or passenger side longitudinal rain channel bottom surfaces 82 and/or 86 are higher than the opposing aft end of the respective driver side and passenger side longitudinal rain channel bottom surfaces 82 and 86. Thus, fluids will shed from the domed center panel 48 into the rain channels 30, 38, 42 and 46, and flow along the driver side and/or passenger side longitudinal rain channels 42 and/or 46 from the forward end to the aft end of the respective longitudinal rain channel 42 and/or 46. The fluids can then flow through one or more outlet channels 66 located at the aft end, i.e., lower end, of the driver side and/or passenger side rain channel 42 and 46, to flow off of the canopy 14. In other various embodiments, the aft end of the driver side and/or passenger side longitudinal rain channel bottom surfaces 82 and/or 86 are higher than the opposing forward end of the respective driver side and passenger side longitudinal rain channel bottom surfaces 82 and 86. Thus, fluids will shed from the domed center panel 48 into the rain channels 30, 38, 42 and 46, and flow along the driver side and/or passenger side longitudinal rain channels 42 and/or 46 from the aft end to the forward end of the respective longitudinal rain channel 42 and/or 46. The fluids can then flow through one or more outlet channels 66 located at the forward end, i.e., lower end, of the driver side and/or passenger side rain channel 42 and 46, to flow off of the canopy 14. The outlet channel(s) 66 can be located anywhere along the canopy outer edge 70 to selectively direct fluids off the canopy top side 34 at a desirable location.

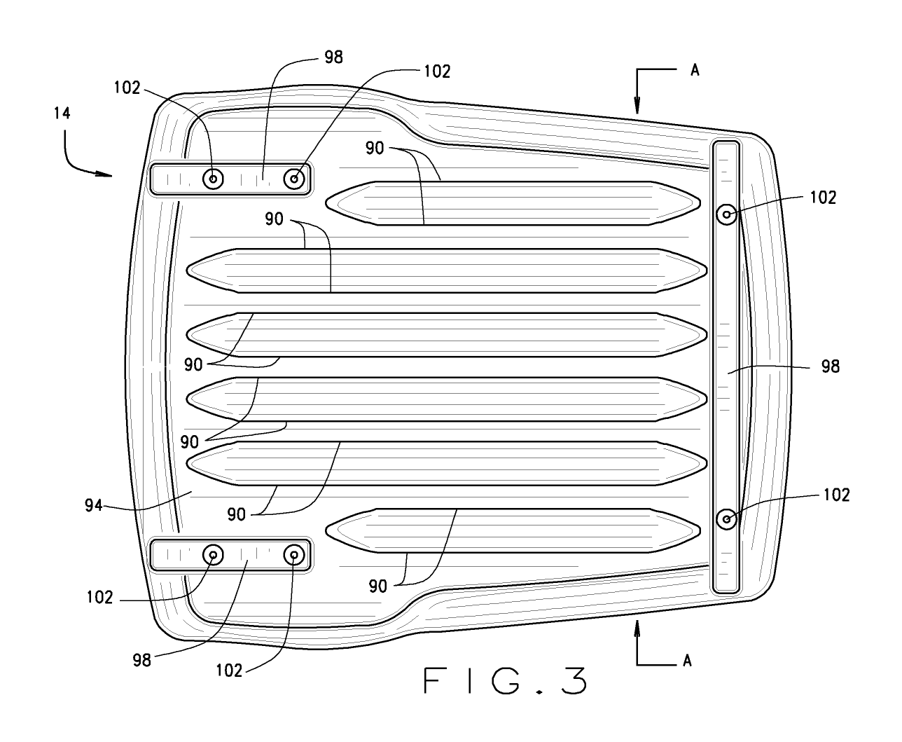

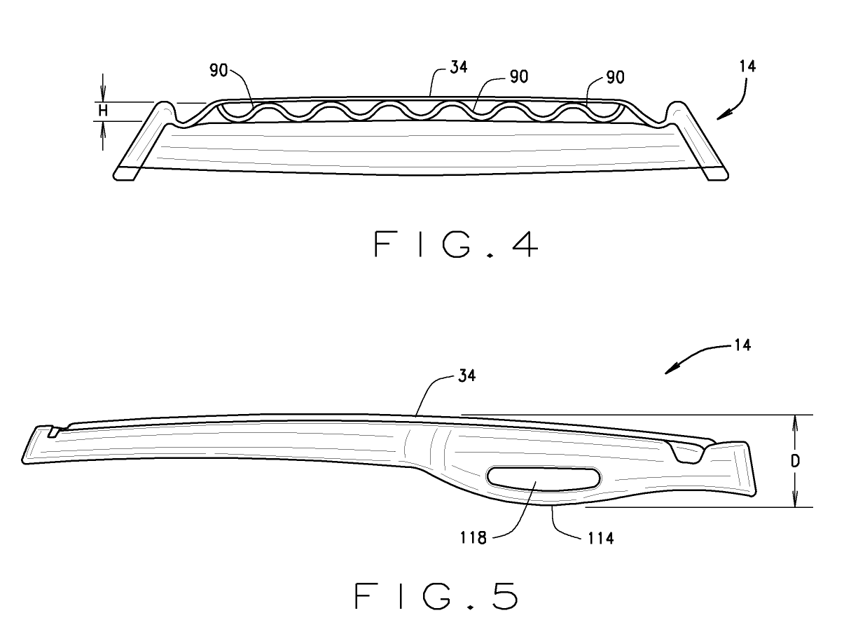

Referring now to FIGS. 3 and 4, in various embodiments, the canopy 14 includes a plurality of reinforcement ribs 90 formed in a bottom side 94. The reinforcement ribs 90 are formed within the bottom side 94 to have height H sufficient to provide substantial support and rigidity to the canopy 14. Particularly, the reinforcement ribs 90 provide substantial support and rigidity such that the domed center panel 48 will remain domed and shed fluids to the rain channels 30, 38, 42 and 46, regardless of duration and intensity of exposure to various environmental elements, such as sun, heat, cold, rain, sleet, hail and snow. In various embodiments, the reinforcement ribs 90 provide load bearing support and rigidity to the canopy 14 such that domed center panel 48 will remained domed and not collapse when bearing various loads such as accumulated snow, sleet or ice. For example, in various embodiments, the reinforcement ribs 90 are formed within the bottom side 94 to have height H of between approximately ¾ inch and 3 inches, for example, between approximately 1 inch and 2 inches. The reinforcement ribs 90 can have any form and configuration suitable to provide support and rigidity described above. For example, the reinforcement ribs 90 can be formed within the bottom side 94 to have a ‘wave-like’ pattern, a ‘saw-tooth’ pattern, or form a plurality of recessed reservoirs. Additionally, exemplarily, the reinforcement ribs 90 can be formed within the bottom side 94 to traverse the bottom side 94 longitudinally, i.e., from the forward portion to the aft portion of the canopy 14, laterally, i.e., from side-to-side, diagonally or in a criss-crossed fashion.

With further reference to FIG. 3, in various embodiments, the canopy 14 includes at least one strut pocket 98 formed in a bottom side 94. The strut pocket(s) 98 is/are recesses formed in the bottom side 94 to receive, locate, secure and at least partially conceal an end portion of at least one of the canopy support struts 26. The strut pocket(s) 98 is/are formed to have a shape, i.e., internal form, generally matching and cooperative with the shape of the end portion of the respective support strut 26. The end portion of the respective support strut(s) 26 is/are positioned within the respective strut pocket and the canopy 14 is attached or mounted to the end portion(s) using any suitable fastening device (not shown). For example, in various embodiments, the canopy 14 includes at least one attachment hole 102 through which a threaded fastening device, e.g., a screw or bolt, is inserted and coupled with the end portion of the respective support strut 26. Furthermore, in various embodiments, the strut pocket(s) 98 is/are formed to have a depth sufficient to conceal from view at least a substantial portion, e.g., at least the sides, of the end portion of the respective support strut 26. The strut pockets 98 provide an aesthetically appealing appearance to the bottom side 94 when the canopy 14 is coupled to the support struts 26. Additionally, the strut pockets 98 provide protection from vehicle passenger(s), i.e., driver and/or rider(s), bumping their head on the end portion of the support struts 26.

Referring now to FIG. 2, in various embodiments, the canopy 14 additionally includes a plurality of ported recesses 106 formed in the top side 34. Each ported recess 106 includes one of the attachment holes 102 therewithin. As fluid sheds from the domed center panel 48, the fluid can collect within the ported recesses 106 and around the fasteners (not shown) inserted through the respective attachment holes 102. Each ported recess 106 is formed to include a port 110 configured to channel the fluid collecting within the respective ported recess 106 into one of the forward lateral rain channel 30, the aft lateral rain channel 38, the passenger side longitudinal rain channel 46 or the driver side longitudinal rain channel 42. The fluid can then flow through the rain channels 30, 38, 42 and/or 46 and be dispersed off the canopy 14 via the outlet channel(s) 66, as described above.

Referring now to FIGS. 2, 4 and 5, as described above, the domed center panel 48 of the canopy 14 is domed to shed fluids into the rain channels 30, 38, 42 and 46. More specifically, the domed center panel 48, and in various embodiments the entire canopy top side 34 has a crowned lateral profile, as shown in FIG. 4 and crowned longitudinal profile, as shown in FIG. 5. That is, a center portion of the domed center panel 48 is higher than the forward and aft end portions of the top side 34, as shown FIG. 5, and higher than the driver side and passenger side end portions of the top side 34, as shown in FIG. 4. For example, the center portion of the domed center panel 48 can be passenger side longitudinal rain channel bottom surfaces 82 and/or 86 can be between approximately ½ inch and 1½ inch higher than the forward and aft end portions of the top side 34, and between approximately ½ inch and 1½ inch higher than the driver side and passenger side end portions of the top side 34.

Referring now to FIG. 5, in various embodiments the canopy 14 further includes a pair of grab handles 114 on opposing sides of the canopy 14. That is, the driver side and the passenger side of the canopy 14 each include a grab handle 114. The grab handles 114 can be grabbed by vehicle passengers and utilized to assist entering and exiting the passenger compartment 22. In various embodiments, the grab handles 114 extend downward toward the passenger compartment a distance D that is calculated to ergonomically locate the grab handles 114 without locating the grab handles 114 where they might interfere with the passenger(s) entering and/or exiting the passenger compartment 22. For example, in various embodiments, the distance can be between approximately 5 and 7 inches. Additionally, in various embodiments, the grab handles 114 are formed with the canopy 14 such that the grab handles 114 are within the vehicle envelope. That is, the grab handles 114 do not protrude or extend outwardly away from the canopy 14 where there may be a potential for the grab handles to collide or contact an object the vehicle 10 is passing, e.g., a tree, building or another vehicle 10. Therefore, if the vehicle 10 is driven past such an object, the grab handles 114 will not contact or collide with the object. Additionally, in various embodiments, to enhance the ergonomic design and location of the grab handles 114, the grab handles 114 are formed to have oversized dimensions. That is, the grab handles 114 and grab handle finger openings 118, formed within the grab handles 114, are considerably larger than needed for a passenger having a large hand to easily and securely grasp when entering and/or exiting the passenger compartment 22. For example, in various embodiments, the grab handles 114 and grab handle finger openings 118 can be approximately 5% to 15% larger than is needed for a passenger having a large hand to easily and securely grasp when entering and/or exiting the passenger compartment 22.

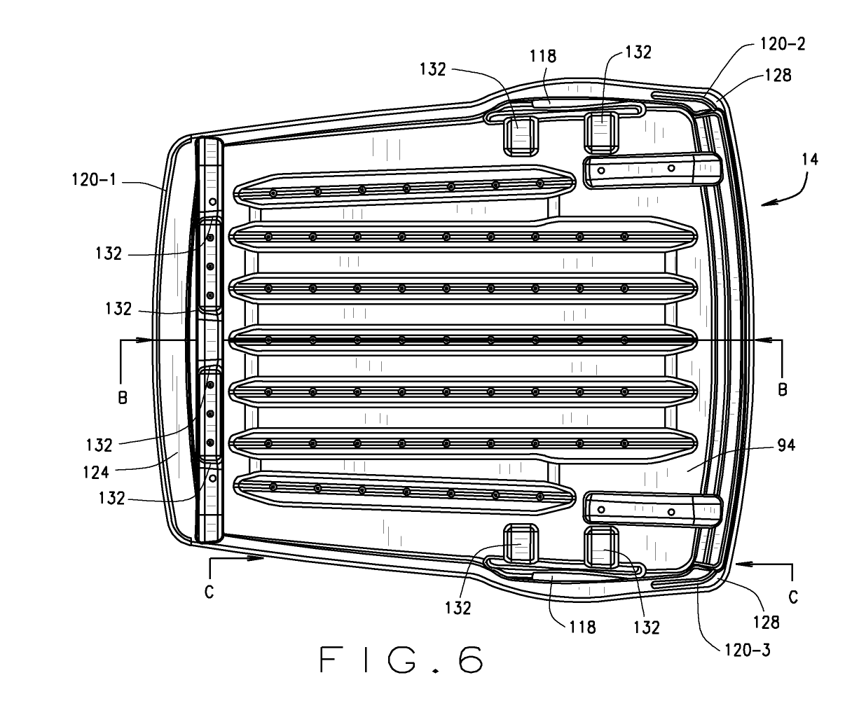

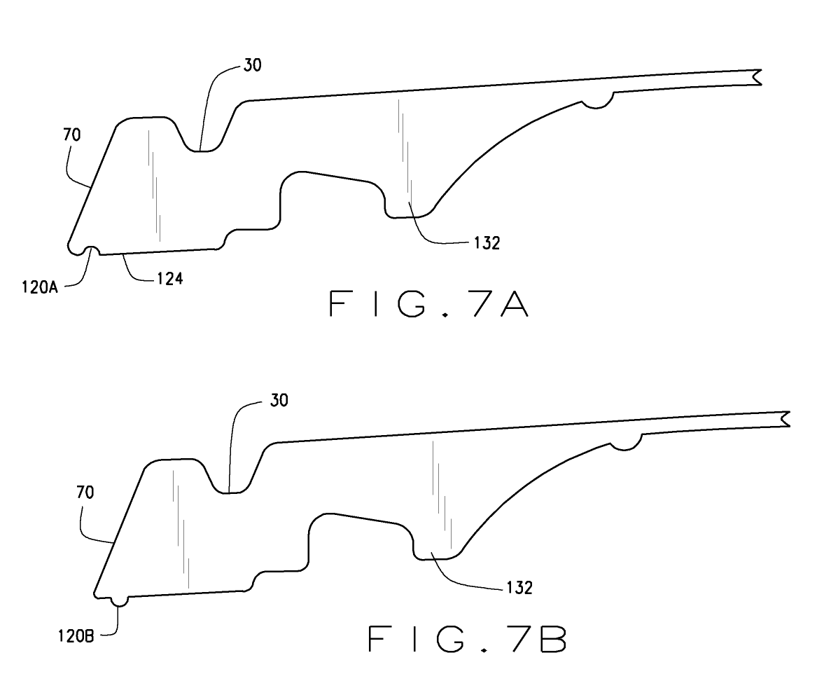

Referring now to FIGS. 6, 7A and 7B, in various embodiments, the bottom side 94 of the canopy 14 can include one or more drip edges 120 along various portion of the outer periphery of the canopy bottom side 94. The drip edges 120 prevent water not channeled by the rain channels 30, 38, 42 and 46 from rolling over the canopy outer edge 70 and dripping on occupants of the vehicle 10. For example, in various implementations, the canopy can include a forward drip edge 120-1 extending across an underside 124 of the forward outer edge 70, and a first and second drip edge 120-2 and 120-3 located along an underside 128 of an aft portion of each of the driver and passenger side outer edges 70.

In various embodiments, as illustrated in FIG. 7A, the drip edges 120 can comprise a recess, indention or channel 120A formed along various portions of the underside, e.g., undersides 124 and 128, of the canopy outer edges 70. However, in various alternative embodiments, as illustrated in FIG. 7B, the drip edges 120 can comprise a raised bump, protrusion or ridge 120B formed along various portions of the underside, e.g., undersides 124 and 128, of the canopy outer edges 70. Particularly, the drip edges 120, e.g., the recesses 120A and the ridges 120B, comprise a contour along one or more portions of the canopy outer edge undersides that provide a barrier to prevent water from traveling along the canopy bottom side 94 and dripping onto occupants of the vehicle 10.

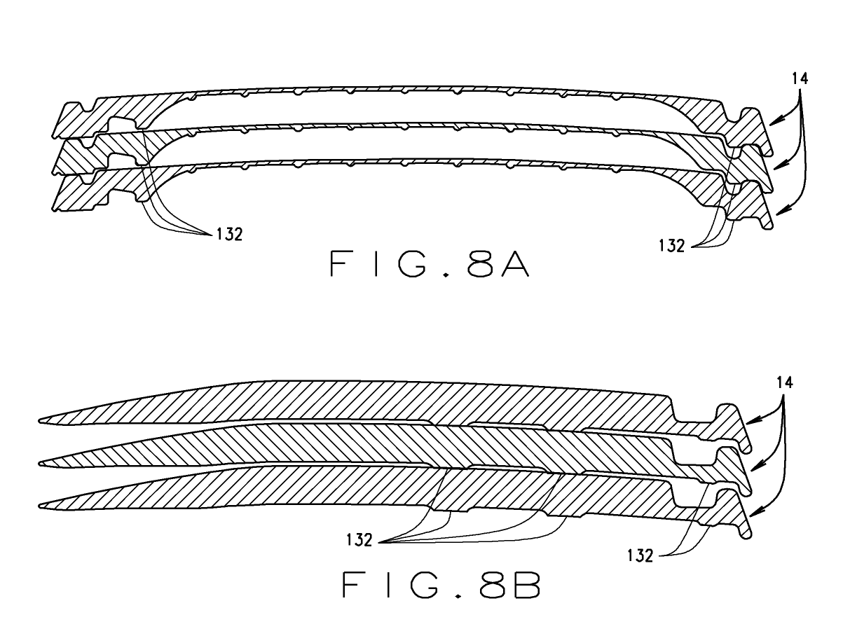

Additionally, in various embodiments, the bottom side 94 of the canopy 14 can include a plurality of standoffs 132 that protrude from the canopy bottom side 94. As illustrated in FIGS. 8A and 8B, the standoffs 132 provide points of support for stacking or nesting a plurality of canopies 14 during storage or transport. That is, the standoffs 132 of each canopy 14 have a predetermined length, or protrusion distance, such that the standoffs 132 of each respective canopy 14 will contact the top side 34 of the canopy immediately beneath each respective canopy 14 when the canopies 14 are nested or stacked. Therefore, the standoffs 132 provide resting or support points for each canopy 14 that aid safely stacking or nesting the canopies 14 and disperse the weight of upper canopies 14 in a stack to thereby prevent damage to the lower canopies in a stack. The standoffs 132 can be located at various locations along bottom side 94 that are predetermined to provide such support, stackability and weight dispersion.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A utility vehicle canopy comprising:
a pair of lateral rain channels formed along a forward portion and an aft portion of a top side of the canopy;
a pair of longitudinal rain channels formed along a driver side portion and a passenger side portion of the canopy and interconnected with the lateral rain channels; and
at least one outlet rain channel formed in the top side of the canopy extending between an outer edge of the canopy and at least one of:
one of the lateral rain channels; and
one of the longitudinal rain channels.

2. The canopy of claim 1, wherein each lateral rain channel is formed within the top side of the canopy having a bottom surface that is crowned such that a center section of each lateral rain channel bottom surface is higher than opposing ends of the respective lateral rain channel.

3. The canopy of claim 1, wherein each longitudinal rain channel is formed within the top side of the canopy having a bottom surface that is sloped such that one end of each longitudinal rain channel is higher than an opposing end of each respective longitudinal rain channel.

4. The canopy of claim 3, wherein the at least one outlet channel extends between the outer edge of the canopy and the lower end of at least one of the longitudinal rain channels.

5. The canopy of claim 1, wherein the canopy further comprises a plurality of reinforcement ribs formed in a bottom side of the canopy.

6. The canopy of claim 1, wherein the canopy further comprises at least one strut pocket formed in a bottom side of the canopy, each strut pocket configured to receive and at least partially conceal an end portion of a canopy support strut.

7. The canopy of claim 1, wherein the canopy further comprises:
a plurality of attachment holes extending through the canopy and configured to have fasteners inserted therethrough to couple the canopy to one or more canopy support struts;
a plurality of ported recesses formed in the top side of the canopy, each ported recess having one attachment hole therewithin.

8. The canopy of claim 1, wherein the top side of the canopy is formed to comprise:
a driver side to passenger side crowned profile; and
a forward to aft crowned profile.

9. A utility vehicle canopy comprising:
a forward lateral rain channel formed along a forward portion of a top side of the canopy for collecting liquid shed from a domed center panel of the canopy;
an aft lateral rain channel formed along an aft portion of a top side of the canopy for collecting liquid shed from the domed center panel of the canopy;
a driver side longitudinal rain channel formed along a driver side portion of the canopy for collecting liquid shed from the domed center panel of the canopy, the driver side longitudinal rain channel interconnected between a driver side end of the forward lateral rain channel and driver side end of the aft lateral rain channel such that the liquid can flow from the lateral rain channels into the driver side longitudinal rain channel
a passenger side longitudinal rain channel formed along a passenger side portion of the canopy for collecting liquid shed from the domed center panel of the canopy, the passenger side longitudinal rain interconnected between a passenger side end of the forward lateral rain channel and passenger side end of the aft lateral rain channel such that the liquid can flow from the lateral rain channels into the passenger side longitudinal rain channel; and
at least one outlet rain channel formed in the top side of the canopy extending between an outer edge of the canopy and at least one of:
one of the forward and aft rain channels; and
one of the driver side and passenger side longitudinal rain channels,
such that liquid flowing through the lateral and longitudinal rain channels will flow through the outlet rain channel and off of the canopy.

10. The canopy of claim 9, wherein each of the forward and aft lateral rain channels are formed within the top side of the canopy having a bottom surface that is crowned such that a center section of the respective forward and aft lateral rain channel bottom surface is higher than opposing ends of the respective forward and aft lateral rain channel, thereby causing liquid flowing within the forward and aft lateral rain channels to flow from the center sections toward the opposing ends of the respective forward and aft lateral rain channels.

11. The canopy of claim 9, wherein each of the driver side and passenger side longitudinal rain channels are formed within the top side of the canopy having a bottom surface that is sloped such that one end of each driver side and passenger side longitudinal rain channel is higher than an opposing end of each respective driver side and passenger side longitudinal rain channel, thereby causing the liquid flowing with the driver side and passenger side longitudinal rain channels to flow from the high ends to the low ends.

12. The canopy of claim 11, wherein the at least one outlet channel extends between the outer edge of the canopy and the lower end of at least one of the driver side and passenger side longitudinal rain channels.

13. The canopy of claim 9, wherein the canopy further comprises a plurality of reinforcement ribs formed in a bottom side of the canopy, the reinforcement ribs adapted to provide strength and rigidity to the canopy.

14. The canopy of claim 9, wherein the canopy further comprises at least one strut pocket formed in a bottom side of the canopy, each strut pocket configured to receive and at least partially conceal an end portion of a canopy support strut.

15. The canopy of claim 9, wherein the canopy further comprises:
a plurality of attachment holes extending through the canopy and configured to have fasteners inserted therethrough to couple the canopy to one or more canopy support struts;
a plurality of ported recesses formed in the top side of the canopy, each ported recess having one attachment hole therewithin and configured to channel fluid collecting around each attachment hole into one of the forward lateral rain channel, the aft lateral rain channel, the passenger side longitudinal rain channel and the driver side longitudinal rain channel.

16. The canopy of claim 9, wherein the domed center panel comprises:
a driver side to passenger side crowned profile; and
a forward to aft crowned profile.

17. A utility vehicle comprising:
a canopy comprising:
a forward lateral rain channel formed along a forward portion of a top side of the canopy for collecting liquid shed from a domed center panel of the canopy;
an aft lateral rain channel formed along an aft portion of a top side of the canopy for collecting liquid shed from the domed center panel of the canopy;
a driver side longitudinal rain channel formed along a driver side portion of the canopy for collecting liquid shed from the domed center panel of the canopy, the driver side longitudinal rain channel interconnected between a driver side end of the forward lateral rain channel and driver side end of the aft lateral rain channel such that the liquid can flow from the lateral rain channels into the driver side longitudinal rain channel a passenger side longitudinal rain channel formed along a
passenger side portion of the canopy for collecting liquid shed from the domed center panel of the canopy, the passenger side longitudinal rain interconnected between a passenger side end of the forward lateral rain channel and passenger side end of the aft lateral rain channel such that the liquid can flow from the lateral rain channels into the passenger side longitudinal rain channel; and
at least one outlet rain channel formed in the top side of the canopy extending between an outer edge of the canopy and at least one of:
one of the forward and aft rain channels; and
one of the driver side and passenger side longitudinal rain channels,
such that liquid flowing through the lateral and longitudinal rain channels will flow through the outlet rain channel and off of the canopy.

18. The vehicle of claim 17, wherein each of the forward and aft lateral rain channels are formed within the top side of the canopy having a bottom surface that is crowned such that a center section of the respective forward and aft lateral rain channel bottom surface is higher than opposing ends of the respective forward and aft lateral rain channel, thereby causing liquid flowing within the forward and aft lateral rain channels to flow from the center sections toward the opposing ends of the respective forward and aft lateral rain channels.

19. The vehicle of claim 17, wherein each of the driver side and passenger side longitudinal rain channels are formed within the top side of the canopy having a bottom surface that is sloped such that one end of each driver side and passenger side longitudinal rain channel is higher than an opposing end of each respective driver side and passenger side longitudinal rain channel, thereby causing the liquid flowing with the driver side and passenger side longitudinal rain channels to flow from the high ends to the low ends.

20. The vehicle of claim 19, wherein the at least one outlet channel extends between the outer edge of the canopy and the lower end of at least one of the driver side and passenger side longitudinal rain channels.

21. The vehicle of claim 17, wherein the canopy further comprises a plurality of reinforcement ribs formed in a bottom side of the canopy, the reinforcement ribs adapted to provide strength and rigidity to the canopy.

22. The vehicle of claim 17, wherein the canopy further comprises at least one strut pocket formed in a bottom side of the canopy, each strut pocket configured to receive and at least partially conceal an end portion of a canopy support strut.

23. The vehicle of claim 17, wherein the canopy further comprises:
a plurality of attachment holes extending through the canopy and configured to have fasteners inserted therethrough to couple the canopy to one or more canopy support struts;
a plurality of ported recesses formed in the top side of the canopy, each ported recess having one attachment hole therewithin and configured to channel fluid collecting around each attachment hole into one of the forward lateral rain channel, the aft lateral rain channel, the passenger side longitudinal rain channel and the driver side longitudinal rain channel.

24. The vehicle of claim 17, wherein the domed center panel comprises:
a driver side to passenger side crowned profile; and
a forward to aft crowned profile.

25. The canopy of claim 1 further comprising one or more drip edges along various portion of an outer periphery of a bottom side of the canopy that are structured to prevent water from rolling over an outer edge dripping off central, non-periphery portion of the canopy bottom side.

26. The canopy of claim 1 further comprising a plurality of standoffs protruding from a bottom side of the canopy to provide support and weight dispersion that aids in stacking a plurality of canopies during storage and transport.
